(19) United States
(12) Patent Application Publication
(10) Pub. No.: US 2021/0285548 A1
(43) Pub. Date: Sep. 16, 2021

(54) Valve Stem Seal and Assembly

(71) Applicant: Dana Automotive Systems Group, LLC, Maumee, OH (US)

(72) Inventor: Troy D. McArthy, LaOtto, IN (US)

(73) Assignee: Dana Automotive Systems Group, LLC, Maumee, OH (US)

(21) Appl. No.: 16/818,538

(22) Filed: Mar. 13, 2020

(51) Int. Cl. F16J 15/3236; F16K 1/46

(52) U.S. Cl. CPC F16J 15/3236; F16K 1/303; F16K 1/465

(57) ABSTRACT

A valve stem sealing assembly may have an elastomeric seal with an upper sealing lip, a middle sealing lip, and a lower sealing lip on an inner surface. The seal may have an outer surface with a spring groove, an upper retainer flange, and a retainer groove. The assembly may also have a retainer with a radially extending leg and an axially extending leg, where the retainer is mechanically locked to the seal.

### FIELD

A valve stem seal and assembly to seal a space between a valve stem and a valve guide, such as in an internal combustion engine, are described and depicted.

### BACKGROUND

Valve stem seal assemblies are devices that seal a space between a valve stem and a valve guide of an intake/exhaust valve, which reciprocates in an internal combustion engine. During the intake cycle of the engine, a reduced pressure is created in the cylinder. This reduced pressure can draw lubricating oil along the valve stem where it ends up in into the combustion chamber. Oil in the combustion chamber can result in inefficient operation of the engine and undesirable white smoke from the exhaust. The assemblies are designed to reduce, or prevent, lubricating oil from entering into the combustion chamber along the valve stem. The assemblies also prevent gases from the combustion chamber from escaping.

As engine manufacturers strive for increased engine performance, increased engine temperatures and pressures result. Traditional valve stem assembly designs are not robust enough to handle the increase in pressure and temperature, which results in the assemblies leaking oil and/or combustion gases.

In view of the disadvantages associated with traditional valve stem assembly designs, a valve stem seal and assembly is needed to handle the higher pressure and higher temperature environments of today's engines.

### SUMMARY

In one embodiment, a valve stem sealing assembly may have an elastomeric seal with an upper surface, an inner surface, a lower surface and an outer surface. The inner surface may have an upper sealing lip with a planar sealing surface. The inner surface may also have a middle sealing lip having a curved sealing surface defined by a first radius. The inner surface may also have a lower sealing lip having a curved sealing surface defined by a second radius that is smaller than the first radius. In some embodiments, compared with the middle sealing lip and the lower sealing lip, the planar sealing surface of the upper sealing lip may have the largest axial sealing length. The seal may terminate at the lower surface. The lower surface may be defined in part by the lower sealing lip, and a bottom groove between the lower sealing lip and a planar seat. The seal may also have an outer surface. The outer surface may have a spring groove radially opposite the upper sealing lip. The outer surface may also have an upper retainer flange axially between the upper sealing lip and the lower sealing lip and below the spring groove. A retainer groove may be located between the upper sealing lip and the lower sealing lip and below the upper retainer flange. A spring may be captured in the spring groove between the spring flange and the upper retainer flange. A retainer may have a radially extending leg and an axially extending leg. The retainer may axially terminate at the first radially extending leg where it is mechanically locked between the upper retainer flange and a lower retainer flange. The axially extending leg axially terminates above the upper surface.

In another aspect, the upper sealing lip may be axially displaced from the upper surface by an upper groove, where the upper groove comprises an upper conically shaped wall and a radiused portion positioned axially below.

In another aspect, the upper sealing lip may be nonsymmetrical in the axial direction, where the planar sealing surface of the upper sealing lip may be located between an upper inner radius portion and a lower outer radius portion of the upper sealing lip where a radius of the upper inner radius portion may be smaller than a radius of the lower outer radius portion.

In another aspect, the middle sealing lip may be axially displaced from the upper sealing lip by a middle groove, where the middle groove may have larger radius than a radius of a lower groove.

In another aspect, the second middle sealing lip may have a line of symmetry parallel to the axial direction.

In another aspect, the lower sealing lip may be axially displaced from the middle sealing lip by a lower groove, where the lower groove may have a radius larger than a radius of the middle sealing lip.

In another aspect, the lower sealing lip may have a line of symmetry offset from the axial direction.

In another aspect, the bottom groove may have a smaller radius than a radius of the lower sealing lip, where the bottom groove has a height at least half the axial length of the third lower sealing lip.

In another aspect, the planar seat may extend parallel and coplanar a lowermost portion of the lower sealing lip.

In another aspect, the spring groove may extend radially into the seal radially further than the retainer groove.

In another aspect, a lower retainer flange outermost wall may extend radially beyond the upper retainer flange, and the lower retainer flange outermost wall may extend perpendicular to the planar seat.

In another embodiment, a valve stem seal may have an upper sealing lip with a planar sealing surface. The seal may also have a middle sealing lip with a curved sealing surface defined by a first radius. The seal may also have a lower sealing lip with a curved sealing surface defined by a second radius that is smaller than the first radius. The seal may axially terminate at a lower surface, where the lower surface may be defined in part by the lower sealing lip, and a bottom groove between the lower sealing lip and a planar seat. A spring groove may be located radially opposite the upper sealing lip. An upper retainer flange may be axially located between the upper sealing lip and the lower sealing lip and below the spring groove. A retainer groove may be located between the upper sealing lip and the lower sealing lip and below the upper retainer flange.

In another aspect, an upper groove may be provided axially above the upper lip, where the upper groove may comprise an upper conically shaped wall and a radiused portion axially below the upper conically shaped wall.

In another aspect, a middle groove may be provided axially below the upper lip, where middle groove may not radially extend into the seal to the radial extent the upper groove extends into the seal.

In another aspect, a lower groove may be provided below the middle sealing lip, where the lower groove may have a radius larger than a radius of the middle sealing lip.

### BRIEF DESCRIPTION OF THE DRAWINGS

The various embodiments will become readily apparent to those skilled in the art from the following detailed description when considered in the light of the accompanying drawings in which:

FIG. 1 is an upper perspective view of one embodiment of a valve stem seal assembly;

FIG. 2 is a plan view of the embodiment in FIG. 1;

FIG. 3 is a cross-section along line 3-3 in FIG. 2;

FIG. 4 is a detail from FIG. 3;

FIG. 5 is a detail from FIG. 3;

FIG. 6 is an upper perspective view of a retainer from FIG. 1;

FIG. 7 is a cross-section along line 7-7 in FIG. 6; and

FIG. 8 is a detail from FIG. 7.

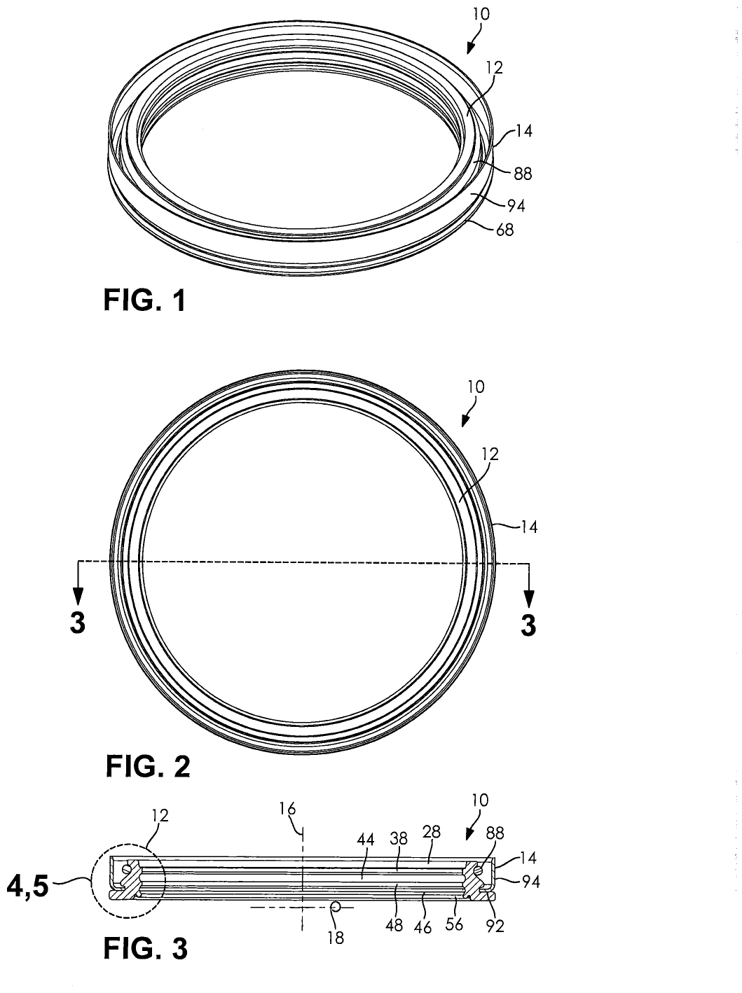

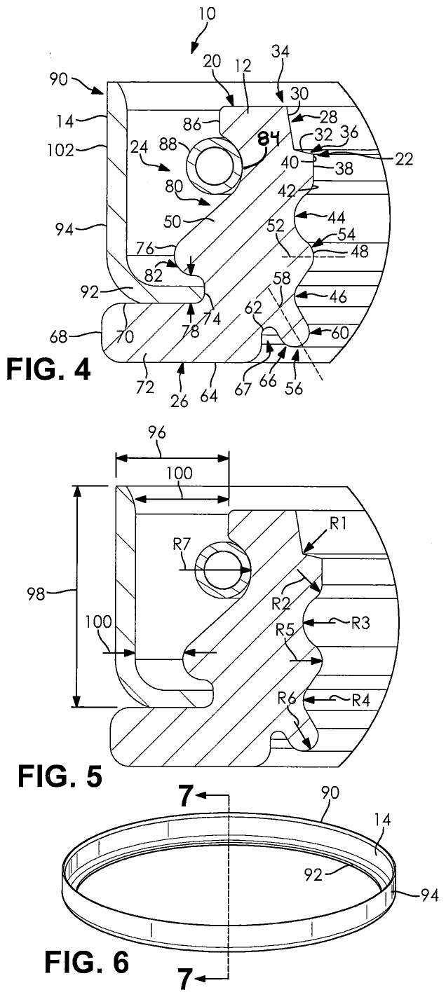

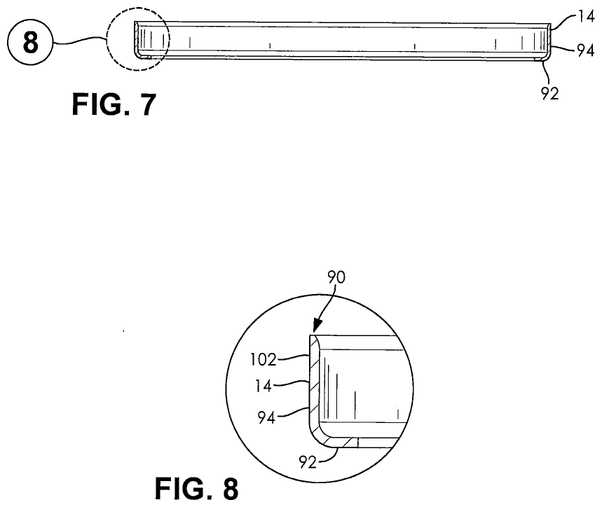

### DETAILED DESCRIPTION OF THE PREFERRED EMBODIMENTS

It is to be understood that the device and processes described herein may assume various alternative orientations and step sequences, except where expressly specified to the contrary. It is also to be understood that the specific devices and processes illustrated in the attached drawings, and described in the following specification are simply exemplary embodiments defined in the appended claims. Hence, specific dimensions, directions or other physical characteristics relating to the disclosed embodiments are not to be considered as limiting, unless expressly stated otherwise.

Turning now to the figures, one embodiment of a valve stem sealing assembly 10 is schematically depicted. The assembly 10 may comprise a seal 12 and a retainer 14. An axial direction axis 16 and a radial direction axis 18 for the seal 12 and the retainer 14 are provided on FIG. 3.

The seal 12 may be constructed of an elastomeric material. Many different types of elastomeric materials may be used, but it has been found to be particularly beneficial if the materials are capable of withstanding high temperatures and pressures, such as found in internal combustion engines. It is also advantageous if the seal material can be easily molded so that it does not need a retainer bonded or integrally formed therewith to retain and/or maintain its shape and/or function.

The seal 12 may have a generally toroidal, or closed ring, shape having an upper surface 20, an inner surface 22, an outer surface 24 and a lower surface 26. The seal 12 may be integrally formed, one-piece and unitary.

The upper surface 20 may be the axially terminating surface for the seal 12, there being no additional seal structure axially beyond the upper surface 20. In the depicted embodiment, the upper surface 20 may be entirely planar. The upper surface 20 and the lower surface 26 may be radially bounded by the inner surface 22 and the outer surface 24.

The inner surface 22 extends in the axial direction from the upper surface 20. In one embodiment, an upper groove 28 may be provided in the inner surface 22 immediately adjacent the upper surface 20. In the embodiment in the figures, the upper groove 28 may be comprised of an upper conically shaped wall 30 that terminates in a radiused portion 32 positioned axially to below the upper conically shaped wall 30. The conically shaped wall 30 may be oriented such that the wider, top portion 34 of the cone is adjacent the upper surface 20 and the narrower, bottom portion 36 of the cone is adjacent the radiused portion 32.

The radiused portion 32 may be an upper outer radius portion. The upper outer radiused portion may be part of an upper sealing lip 38. The upper sealing lip 38 may be axially displaced from the upper surface 20 by the upper groove 28.

The upper sealing lip 38 may have a planar sealing surface 40 below the radiused portion 32. The planar sealing surface 40 may extend substantially, or exclusively, in the axial direction. The planar sealing surface 40 is preferably located radially inward from the conically shaped wall 30 of the upper groove 28.

The planar sealing surface 40 may transition to a lower inner radius portion 42. Being that the planar sealing surface 40 is between the upper outer radius portion 32 and the lower inner radius portion 42, the upper sealing lip 38 may be nonsymmetrical in the axial direction. A radius R1 of the upper outer radius portion 32 may be smaller than a radius R2 of the lower inner radius portion 42.

The lower inner radius portion 42 may transition to a middle groove 44. In some embodiments, the middle groove 44 may not radially extend into the seal 12 to the radial extent the upper groove 28 radially extends into the seal 12. The middle groove 44 may have a larger outer radius R3 than an outer radius R4 of a lower groove 46 (described below).

The middle groove 44 may transition to a middle sealing lip 48, which is axially displaced from the upper sealing lip 38 by the middle groove 44. The middle sealing lip 48 may be defined by a constant, inner radius R5 that extends the lip 48 radially away from a body portion 50 of the seal 12. The middle sealing lip 48 may have a line of symmetry 52 that is parallel to the radial direction axis 18. An outermost portion 54 of the lip 48, which may be a curved sealing surface, may be axially aligned with the planar sealing surface 40 of the upper sealing lip 38.

The upper and middle sealing lips 38, 48 may prevent or reduce oil from running down the valve stem (not shown) and into the combustion chamber (not shown) below.

The middle sealing lip 48 may transition to the lower groove 46. In some embodiments, the lower groove 46 may radially extend into the seal 12 to the same, or approximately the same, radial extent as the middle groove 44. The lower groove 46 outer radius R4 may be larger than the inner radius R5 of the middle sealing lip 48.

The lower groove 46 may transition to a lower sealing lip 56, thus the lower sealing lip 56 is axially displaced from the middle sealing lip 48 by the lower groove 46. The lower sealing lip 56 may have a line of symmetry 58 angled from the radial direction axis 18 so that the lower sealing lip 56 has an overall downward angle from the middle sealing lip 48.

The lower sealing lip 56 may function to prevent high pressure gasses in the combustion chamber below the seal 12 from escaping between the seal 12 and the valve stem.

The lower sealing lip 56 may define an inner radius of curvature R6 that is smaller than the radius of curvature R5 for the middle sealing lip 48.

An outermost portion 60 of the lower sealing lip 56, which may be a curved sealing surface, may be axially aligned with the planar sealing surface 40 of the upper sealing lip 38 and the outermost portion 54 of the middle sealing lip 48.

Compared with the outermost portions 54, 60 of the middle and lower sealing lips 48, 56, the planar sealing surface 40 of the upper sealing lip 38 has the largest axial sealing length. This length makes it the primary seal against oil leakage.

The lower sealing lip 56 may transition to a bottom groove 62 that extends into the body portion 50 of the seal 12. The overall, or primary, direction in which the bottom groove 62 extends into the seal body portion 50 is in the axial direction toward the upper surface 20. In the depicted embodiment, the bottom groove 62 does not axially extend to the middle sealing lip 48; it terminates in the seal body portion 50 before it axially reaches the middle sealing lip 48. Preferably, the bottom groove 62 has a height at least half the axial length of the lower sealing lip 56; this provides a predetermined degree of flexibility to the lower sealing lip 56 so that it can seal against the valve stem steal as it reciprocates.

Based on the above, the inner surface 22 of the seal 12 may comprise the upper groove 18, the upper sealing lip 38, the middle groove 44, the middle sealing lip 48, the lower groove 46 and the lower sealing lip 56.

A planar seat 64 is located radially outward from the bottom groove 62. The planar seat 64 may be a planar surface and it may comprise the lower surface 26 of the seal 12. The bottom groove 62 may also be part of the lower surface 26.

A lowermost portion 66 of the lower sealing lip 56 may not be coplanar with the planar seat 64. In the depicted embodiment, the lowermost portion 66 may be axially separated from the planar seat, such as by a predetermined gap 67. The axial height of the gap 67 may vary, but in one embodiment the gap 67 may be approximately ¼ to ¾ the axial length of the lower sealing lip 56. In the same embodiment, the gap 67 may have approximately the same axial dimension as the axial dimension of the bottom groove 62.

The gap 67 may also have a radial dimension. The radial dimension may be such as approximately the radial dimension of the lower sealing lip 56.

If it is even needed at all, the gap 67 may be helpful in providing clearance for engine components, including but not limited to, the valve stem and/or the valve guide.

The planar seat 64 extends parallel and is coplanar with a lowermost portion 66 of the lower sealing lip 56. The lower surface 26 of the seal 12 is the axial terminus of the seal 12 with no other portion of the seal 12 being located below the lower surface 26.

The planar seat 64 extends to a lower retainer flange outermost wall 68. The wall 68 may be a primarily axially extending wall, thus the wall 68 and the planar seat 64 may be oriented substantially transverse one another. The wall 68 connects with a lower retainer flange upper wall 70, which extends parallel to, but axially spaced apart from, the planar seat 64. In some embodiments, the lower retainer flange upper wall 70 has a lesser radial dimension compared with the planar seat 64.

The planar seat 64, the lower retainer flange outermost wall 68 and the lower retainer flange upper wall 70 may define between them a lower retainer flange 72. The flange 72 may have an axial dimension, or thickness, that extends from the planar seat 64 at least to a midpoint of the lower groove 46.

The lower retainer flange upper wall 70 may define in part a retainer groove 74. The retainer groove 74 may also be defined by an upper retainer flange 76. A gap 78, which may be of constant width, separates the lower retainer flange upper wall 70 with the upper retainer flange 76.

The upper retainer flange 76 is located axially above the lower retainer flange 72; it is also axially above, but radially offset from, the lower sealing lip 56 and the lower groove 46. In one embodiment, the upper retainer flange 76 axially overlaps only a portion of the lower retainer flange 72. The upper retainer flange 76 may have an upper conical section 80 connected to a lower inner radius portion 82. The lower inner radius portion 82 may approximately radially align with the middle sealing lip 48 while a portion of the upper conical section 80 may extend radially opposite from the middle groove 44.

The upper conical section 80 may extend radially inward into the body portion 50 of the seal 12 to a spring groove 84. The spring groove 84 is located radially inward in the seal body portion 50 from the retainer groove 74. The spring groove 84 may be located radially opposite the upper sealing lip 38. The spring groove 84 may have an outer radius R7. The spring groove radius R7 may be the largest radius of all radi R1-R6 discussed herein.

The spring groove 84 extends to a spring flange 86. The spring flange 86 may extend parallel, but be radially offset from, the lower retainer flange outermost wall 68. The spring flange 86 extends to the upper surface 20.

Based on the above, the outer surface 24 of the seal 12 may comprise the lower retainer flange outermost wall 68, the lower retainer flange upper wall 70, the retainer groove 74, the upper retainer flange 76, the spring groove 84 and the spring flange 86.

A biasing member 88, such as a coil spring, may be located in the spring groove 84. The biasing member 88 may be continuous or non-continuous, and other biasing members may be used besides coil springs. The biasing member 88 provides a radially inward directed force to the upper sealing lip 38. The force assists the lip 38 in sealing against a valve stem.

The retainer 14 may also be generally toroidal, or closed ring, shaped. The retainer 14 may be of a metallic construction and one-piece, integrally formed and unitary. Further, the majority of the retainer 14 may be of a substantially constant thickness; one exception may be a tapered upper end portion 90.

The retainer 14 may have a radially extending leg 92 and an axially extending leg 94, which together may provide an L-shaped cross section. An axial dimension 96 of the axially extending leg 94 is greater than the radial dimension 98 of the radially extending leg 92.

The radially extending leg 92 may be located within the retainer groove 74 of the seal 12. In this orientation, the radially extending leg 92 becomes mechanically locked between the upper retainer flange 76 and the lower retainer flange 72 of the seal 12. In one embodiment, a larger portion of the radially extending leg 92 is supported by the lower retainer flange 72 compared with the extent to which the upper retainer flange 76 covers the radially extending leg 92.

Preferably, the retainer 14 is not bonded (such as by welding or with adhesive) to the seal 12. It is also preferable that the retainer 14 is not molded into, such as by overmolding, the seal 12. By mechanically connecting the retainer 14 to the seal 12, scrap seal material is advantageously reduced.

The retainer groove 74 is the lowermost point in the assembly 10 in which the retainer 14 extends. In other words, the retainer 14 does not extend below the lower retainer flange 72. Instead, the axially extending leg 94 is directed in an axially upward direction where it axially extends along, but is radially offset from, the middle sealing lip 48 and the upper sealing lip 38. Indeed, the axially extending leg 94 is radially offset from the seal outer surface 24 by a gap 100 that separates the axially extending leg 94 with the seal outer surface 24. An outer surface 102 of the axially extending leg 94 may be radially aligned with the lower retainer flange outermost wall 68. In some embodiments, the axially extending leg 94 extends above the upper surface 20 of the seal 12. As shown in the figures, it may be that the tapered upper end portion 90 extends above the upper surface 20.

In accordance with the provisions of the patent statutes, the device and processes have been described in what is considered to represent its preferred embodiments. However, it should be noted that the device and processes can be practiced otherwise than as specifically illustrated and described without departing from their spirit or scope.

What is claimed is:

1. A valve stem sealing assembly, comprising:
an elastomeric seal comprising an upper surface, an inner surface, a lower surface and an outer surface,
said inner surface, comprising:
an upper sealing lip having a planar sealing surface,
a middle sealing lip having a curved sealing surface defined by a first radius,
a lower sealing lip having a curved sealing surface defined by a second radius that is smaller than the first radius,
wherein compared with the middle sealing lip and the lower sealing lip, the planar sealing surface of the upper sealing lip has the largest axial sealing length,
wherein said seal terminates at said lower surface, said lower surface defined in part by a bottom groove between said lower sealing lip and a planar seat,
said outer surface, comprising:
a spring groove radially opposite said upper sealing lip,
a upper retainer flange axially between said upper sealing lip and said lower sealing lip and below said spring groove,
a retainer groove located between the upper sealing lip and the lower sealing lip and below the upper retainer flange,
wherein a spring is captured in said spring groove between said spring flange and said upper retainer flange,
a retainer having a radially extending leg and an axially extending leg, wherein said retainer axially terminates at said first radially extending leg where it is mechanically locked between said upper retainer flange and a lower retainer flange, wherein said axially extending leg axially terminates above said upper surface.

2. The assembly of claim 1, wherein said upper sealing lip is axially displaced from said upper surface by an upper groove, said upper groove comprising an upper conically shaped wall and a radiused portion positioned axially below.

3. The assembly of claim 1, wherein said upper sealing lip is nonsymmetrical in an axial direction, wherein said planar sealing surface of said upper sealing lip is located between an upper outer radius portion and an lower inner radius portion of said upper sealing lip, where a radius of said upper outer radius portion is smaller than a radius of said lower inner radius portion.

4. The assembly of claim 1, wherein said middle sealing lip is axially displaced from said upper sealing lip by a middle groove, wherein said middle groove has a larger radius than a radius of a lower groove.

5. The assembly of claim 1, wherein said middle sealing lip has a line of symmetry parallel to the axial direction.

6. The assembly of claim 1, wherein said lower sealing lip is axially displaced from said middle sealing lip by a lower groove, wherein said lower groove comprises a radius larger than a radius of said middle sealing lip.

7. The assembly of claim 1, wherein said lower sealing lip has a line of symmetry offset from the axial direction.

8. The assembly of claim 1, wherein said bottom groove has a smaller radius than a radius of said lower sealing lip, wherein said bottom groove has an axial length at least half the axial length of said lower sealing lip.

9. The assembly of claim 1, wherein said planar seat is separated from said lower sealing lip by an axial and radial gap so that said planar seat is not coplanar with said lower sealing lip.

10. The assembly of claim 1, wherein said spring groove extends radially into said seal radially further than said retainer groove.

11. The assembly of claim 1, wherein a lower retainer flange outermost wall extends radially beyond said upper retainer flange, said lower retainer flange outermost wall extending perpendicular to said planar seat.

12. A valve stem seal, comprising:
an upper sealing lip having a planar sealing surface,
a middle sealing lip having a curved sealing surface defined by a first radius,
a lower sealing lip having a curved sealing surface defined by a second radius that is smaller than the first radius,
wherein said seal axially terminates at a lower surface, said lower surface defined in part by a bottom groove between said lower sealing lip and a planar seat,
a spring groove radially opposite said upper sealing lip,
a upper retainer flange axially between said upper sealing lip and said lower sealing lip and below said spring groove,
a retainer groove located between the upper sealing lip and the lower sealing lip and below the upper retainer flange.

13. The seal of claim 12, wherein an upper groove is provided axially above said upper lip, said upper groove comprising an upper conically shaped wall and a radiused portion axially below the upper conically shaped wall.

14. The seal of claim 13, wherein a middle groove is provided axially below the upper lip, said middle groove does not radially extend into the seal to the radial extent the upper groove extends into the seal.

15. The seal of claim 12, wherein a lower groove is provided below the middle sealing lip, said lower groove has a radius larger than a radius of the middle sealing lip.
